(19) United States
(12) Patent Application Publication
(10) Pub. No.: US 2014/0082383 A1
(43) Pub. Date: Mar. 20, 2014

(54) PREDICTING USER INTENT AND FUTURE INTERACTION FROM APPLICATION ACTIVITIES

(71) Applicant: APPLE INC., Cupertino, CA (US)

(72) Inventors: Joshua P. De Cesare, Campbell, CA (US); Gaurav Kapoor, Santa Clara, CA (US); Jonathan J. Andrews, San Jose, CA (US)

(73) Assignee: Apple Inc., Cupertino, CA (US)

(21) Appl. No.: 13/623,417

(22) Filed: Sep. 20, 2012

(51) Int. Cl. G06F 1/32; G06F 1/26

(52) U.S. Cl. 713/320; 713/300

(57) ABSTRACT

Techniques for power management of a portable device are described herein. According to one embodiment, a user agent of an operating system executed within a portable device is configured to monitor activities of programs running within the portable device and to predict user intent at a given point in time and possible subsequent user interaction with the portable device based on the activities of the program. Power management logic is configured to adjust power consumption of the portable device based on the predicted user intent and subsequent user interaction of the portable device, such that remaining power capacity of a battery of the portable device satisfies intended usage of the portable device.

### RELATED APPLICATIONS

This application is related to co-pending U.S. patent application Ser. No. ______, entitled “Inferring User Intent from Battery Level and Charging Trends,” attorney docket No. 4860P15342, filed September ______, 2012.

### FIELD OF THE INVENTION

Embodiments of the present invention relate generally to power management of portable devices. More particularly, embodiments of the invention relate to predicting user intent and future interaction from application activities for power management purposes.

### BACKGROUND

Power management on a data processing system often involves techniques for reducing the consumption of power by components in the data processing system. A data processing system may be a laptop or otherwise portable computer, such as a handheld general purpose computer or a cellular telephone. The management of power consumption in a portable device which is powered by a battery is particularly important because better power management usually results in the ability to use the portable device for a longer period of time when it is powered by one or more batteries.

As devices become more complicated and their capabilities more varied, it becomes increasingly difficult to make the best power management decisions from deep within the system. While designers have been successful making decisions about the hardware state within a central power management driver, they are not able to account for blocks outside the hardware.

Users of battery powered devices generally prefer that the battery does not run out while they are using the device. User level power management may try to extend the life of the battery by reducing power consumption at the cost of reduced performance as the battery approaches depletion. Most of the conventional systems perform such power management actions only when the battery is already very low. Sometimes this may amount to too little too late.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating an example of a portable device according to one embodiment of the invention.

FIG. 2 is a block diagram illustrating a hardware configuration of a portable device according to one embodiment of the invention.

FIG. 3 is a block diagram illustrating an example of a user level power management system according to one embodiment of the invention.

FIG. 4 is a flow diagram illustrating a method for inferring user intent from battery usage heuristics and charging pattern according to one embodiment of the invention.

FIG. 5 is a flow diagram illustrating a method for inferring user intent from battery usage heuristics and charging pattern according to another embodiment of the invention.

FIG. 6 is a block diagram illustrating a user level power management system according to another embodiment of the invention.

FIG. 7 is a flow diagram illustrating a method for user level power management according to another embodiment of the invention.

FIG. 8 is a flow diagram illustrating a method for user level power management according to another embodiment of the invention.

FIG. 9 is a block diagram illustrating an example of a data processing system which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a user agent, also referred to as an adaptive user experience manager, is designed to set a device's various performance vs. efficiency knobs how the user would have set them if the knobs were exposed to the user. Since performance and efficiency are typically opposing goals, a new metric is needed to optimize the various knobs. It encapsulates whatever is best for the user. At times this could be the higher performance. At other times it could be long batter life (power efficiency).

According to one embodiment, the user agent utilizes a collection of competing heuristics to intuit the user goal and then decide how best to manage the performance and efficiency of the device's various blocks to achieve the user's goal. The heuristics draw information from the applications the user runs, sensors (ambient light, motions (e.g., gyro), location (e.g., global positioning system or GPS), wireless network availability, etc.) collecting data about the user's environment, and from the user's physical interactions with the device (screen on/off, power adapter attach/detach, etc.). The user agent then evaluates the information from the various heuristics and then selects the best tuning between performance and efficiency for each of the blocks it can manage.

One area of focus is instantaneous and long term power budgeting. At any given time the information from the heuristics indicates how best to allocate the limited power budge (limited by power supply design or the device's thermal capability) between the various devices. One could imagine the user being happy with a slightly darker screen when in a dark room if it means that more power can be given to the GPU and the performance of the game increased. Long term power budgeting is concerned with ensuring that the device's power usage over time does not deplete the battery and interrupt the user. These types of power budgeting help provide bounds on the knobs in the system and can limit which or how much the various heuristics can be applied.

According to one aspect, daily battery usage level and charging pattern (e.g., the frequency the user charges the device's battery) are tracked, and trends can be created about the user's behavior. Deviation from these trends can also signal a more immediate change in the user's intent. According to another aspect, activities of applications running within a portable device are monitored via application programming interfaces (APIs) and the activities may be utilized to infer user intent of using the portable device.

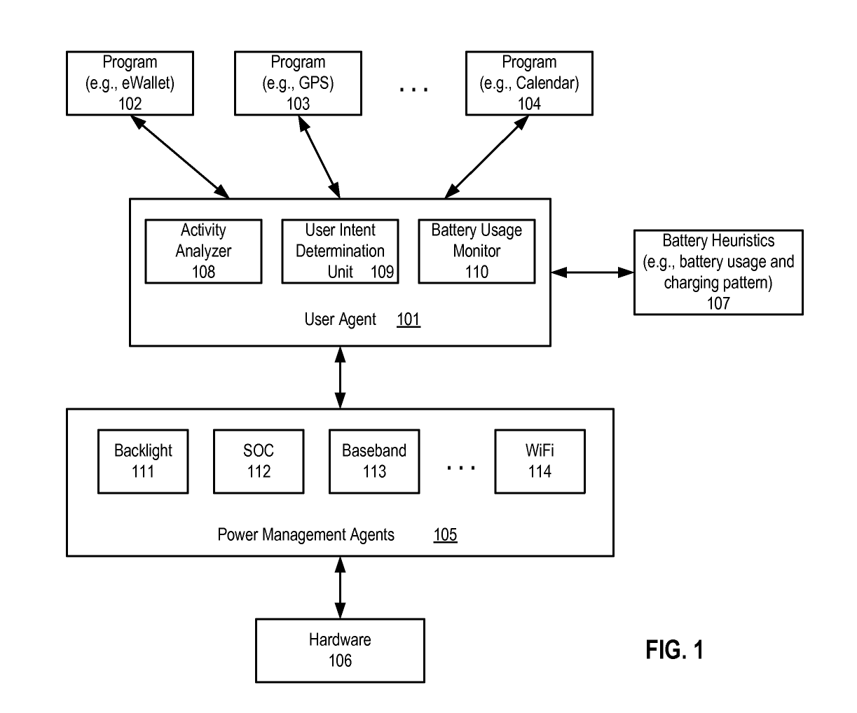

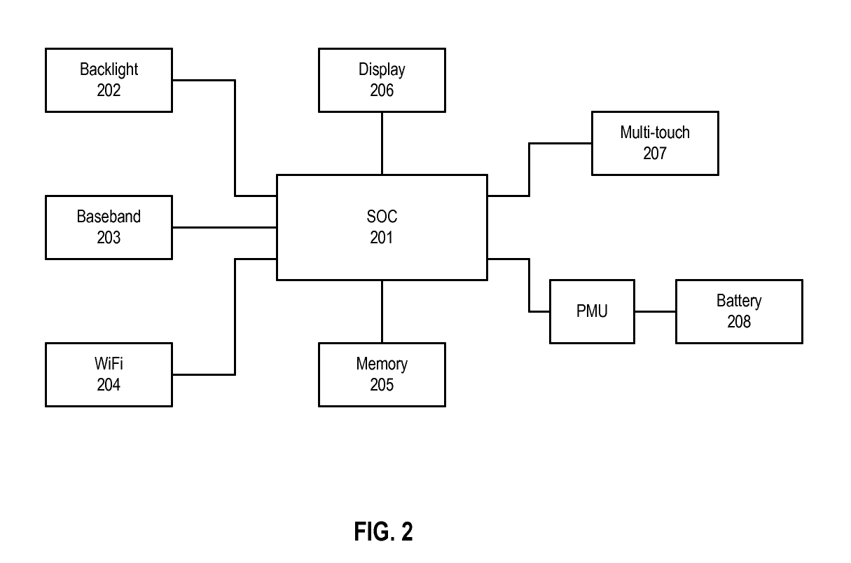

FIG. 1 is a block diagram illustrating an example of a portable device according to one embodiment of the invention. For example, portable device 100 may be a Smartphone (e.g., iPhone), a media player (e.g., iPod), a tablet (e.g., iPad), a laptop (e.g., Mac Book), etc. Referring to FIG. 1, portable device 100 includes a user agent 101, also referred to as an adaptive user experience manager, to communicate with programs 102-104 to monitor activities of programs 102-104, where programs 102-104 may be running at a user space (e.g., applications) or a kernel space (e.g., device drivers) of an operating system of portable device 100. In addition, user agent 101 is coupled to multiple power management agents (PMAs) 105 to obtain power management status of hardware 106 and/or to perform certain power management actions on hardware 106 via the corresponding PMAs that include, but not limited to, backlight agent 111, system-on-chip (SOC) agent 112, baseband (e.g., RF frontend) agent 113, and WiFi agent 114. Hardware 106 represents a variety of hardware devices, such as SOC chip 201, backlight circuit 202, baseband circuit 203, WiFi component 204, memory 205, display 206, multi-touch device or keyboard 207, and battery, as shown in FIG. 2.

According to one embodiment, user agent 101 includes battery usage monitor 110 configured to monitor daily batter usage and daily battery charging pattern of portable device 100, and to compile battery heuristics 107 which is stored in a persistent storage device of portable device 100. A particular battery usage level at a given point in time can be used by user intent determination unit 109 to compare with battery heuristics 107 to determine whether the user of portable device 100 is operating in an abnormal condition, in which case certain power management actions may be performed on portable device to accommodate the abnormal usage of the portable device 100.

In one embodiment, user agent 101 includes an activity analyzer 108 to communicate programs 102-104 via a set of APIs to obtain certain activity or event information of programs 102-104. Based on the activities of the programs, user intent determination unit 109 of user agent 101 can interpret or infer user intent of a user that is currently utilizing portable device and/or a period of time that the user intends to use the portable device without charging the battery. Based on the user intent, user agent 101 may instruct at least some of the PMAs 111-114 to perform certain power management actions on hardware 106. In addition, user agent 101 may further communicate with one or more of programs 102-104 to cause the programs to adjust (e.g., increase or reduce) certain performance of the programs in an attempt to optimize the utilization of the remaining power capacity of the battery.

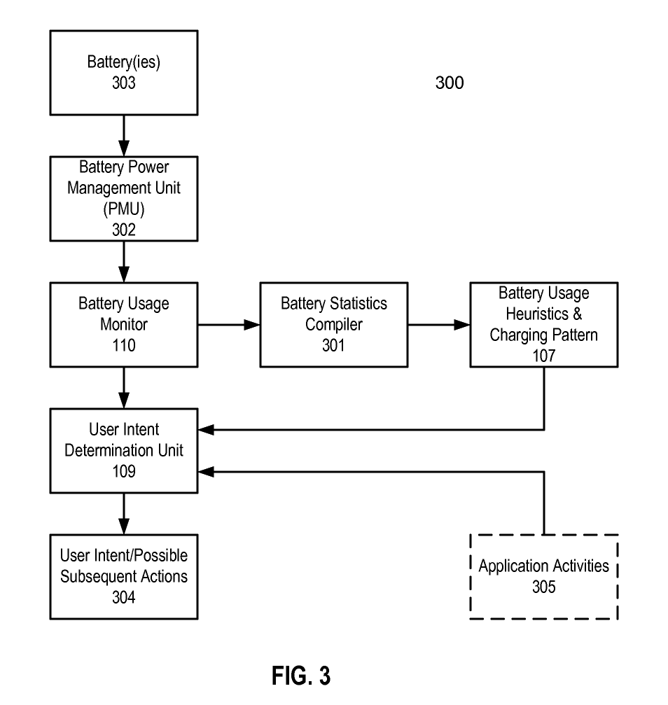

FIG. 3 is a block diagram illustrating an example of a user level power management system according to one embodiment of the invention. System 300 may be implemented as part of system 100 of FIG. 1. Referring to FIG. 3, battery usage monitor 110 is configured to monitor battery usage and battery charging data of battery 303 via battery power management unit 302. Battery usage monitor 110 may periodically monitor the battery usage and charging on a daily basis. The data representing the battery usage and charging data are then used by battery statistics compiler 301 to analyze and compile battery heuristics and charging pattern or trends 107, which can be stored in a persistent storage device of the portable device (not shown). Battery usage heuristics and charging pattern 107 may be constantly or periodically updated over a long period of time to develop more accurate trends of battery usage and charging behavior of the user. In one embodiment, battery heuristics compiler 301 may further calculate a daily average battery usage and/or an estimated daily battery charging schedule of the user. As a result, it can roughly determine when and how long in a regular day that the portable device is powered by the battery without charging.

Battery usage heuristics and charging pattern 107 can be used to determine user intent at a given point in time based on the battery usage level at the given point in time. For example, assuming at a given point in time, battery usage monitor 110 receives data representing a battery usage level from battery PMU 302. The battery usage level is used by user intent determination unit 109 to compare with the daily average battery usage level obtained from battery usage heuristics 107 and optional application activities 305 (for example, obtained via activity analyzer 108 of FIG. 1). Based on the comparison, user intent determination unit 109 can determine the user intent and possible subsequent user actions 304 with the portable device. As a result, user intent determination unit 109 is able to approximately determine whether that particular battery level is within a normal battery usage range of a typical day of the user.

According to one embodiment, if the difference between the battery usage level at the point in time and the average daily battery usage level exceeds a predetermined threshold, it may indicate that the battery usage of the portable device is unusual. A power management action may be performed to accommodate such an unusual situation. For example, if the battery usage level is too high compared to the daily average battery usage, power consumption of certain hardware or software may be reduced to conserve power capacity, such that the remaining power capacity can last for the estimated period of time without charging. On the other hand, if the battery usage is too low compared to the average battery usage level, certain performance of the hardware and/or software may be increased (which leads to higher power consumption) as long as the remaining power capacity of the battery can last the estimated period of time without charging. Such power management actions may be performed automatically without user intervention or knowledge.

The above techniques can be applied to a variety of situations. For example, suppose a user charges its device more than once a day from Monday through Friday during a week. If the total charge consumed is less than the battery's capacity, it is likely the user is charging the device because it is convenient, not because the battery is likely to run out. If the charge used in a day exceeds the battery's capacity modestly, it may be worth it to the user for the power management system to be a little conservative about power usage throughout the day to stretch the capacity of the battery and avoid the need to change mid-day. If the charge consumed exceeds the batteries capacity significantly then the user is certainly using its device fully and the power management system's effect on performance to avoid the mid-day charge would likely be upsetting to the user.

In another example, suppose the user charges its device once a day on Monday through Friday during a week, and the battery usage level of the device before it is charged averages out to a level, referred to as a daily average usage level, with a reasonably low standard deviation. This may imply the user's behavior is about the same each weekday. Should on a given weekday, if the battery usage level falls below the average usage level, with some margin, it implies that there is something different about the user's behavior on this day. This boundary crossing of average behavior can inform the power management system that the user is more likely to run out of battery on that particular day, and it may be in their best interest to conserve power.

In a further example, suppose a user charges their device and removes it from charge at approximately the same time each work day. If the standard deviations for the average times are low enough, the power management system could infer the duration of the user's work day. Alternatively, the power management system can infer which time slots (e.g., 9:00 am to 11:00 am and 2:00 pm to 4:00 pm) of a particular work day (e.g., Monday to Friday) consume more power than other time slots. Being able to infer the user's work day would allow the power management system to set power budgets throughout the day in an attempt to ensure that the battery is not depleted before the day is over. Such a power management system operating on user activities or user behavior is referred to herein as a user level power management system, which includes at least user agent 101 of FIG. 1. The goal is to infer the user intent during different time and/or days from the battery usage heuristics and charging pattern, such that the unusual user behavior can be captured early enough before it is too little too late for the power management system to act. As a result, the operations of the portable device can be dynamically configured (in terms of balance of performance and power consumption), such that the user can have the best experience of the portable device.

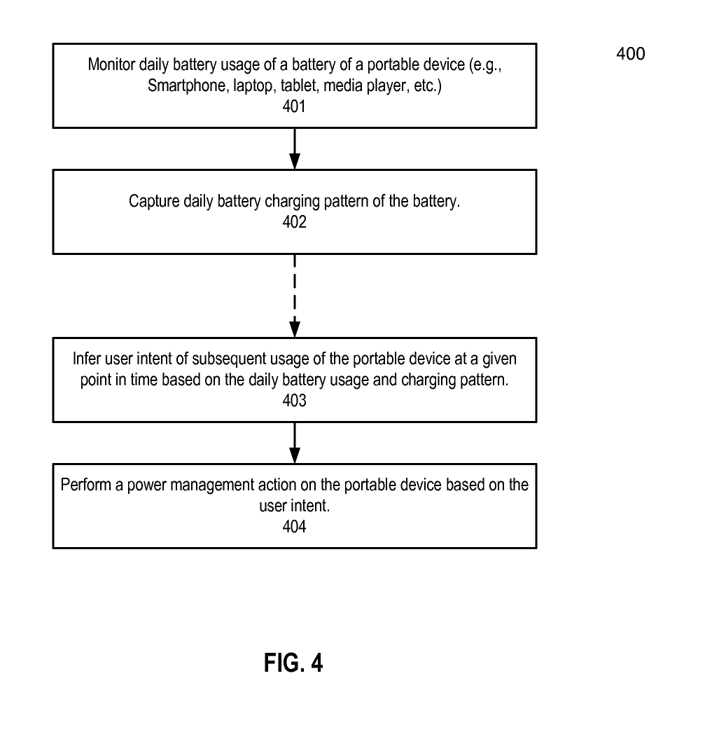

FIG. 4 is a flow diagram illustrating a method for inferring user intent from battery usage heuristics and charging pattern according to one embodiment of the invention. Method 400 may be performed by system 300 of FIG. 3, which may be implemented as processing logic in hardware, software, or a combination thereof. Referring to FIG. 4, at block 401, daily battery usage of a battery of a portable device is monitored and at block 402, daily battery charging pattern is captured. Subsequently at block 403, at a given point in time, the user intent is inferred based on the battery usage level at the point in time in view of the battery usage heuristics and charging pattern. At block 404, a power management action may be performed on the portable device based on the user intent.

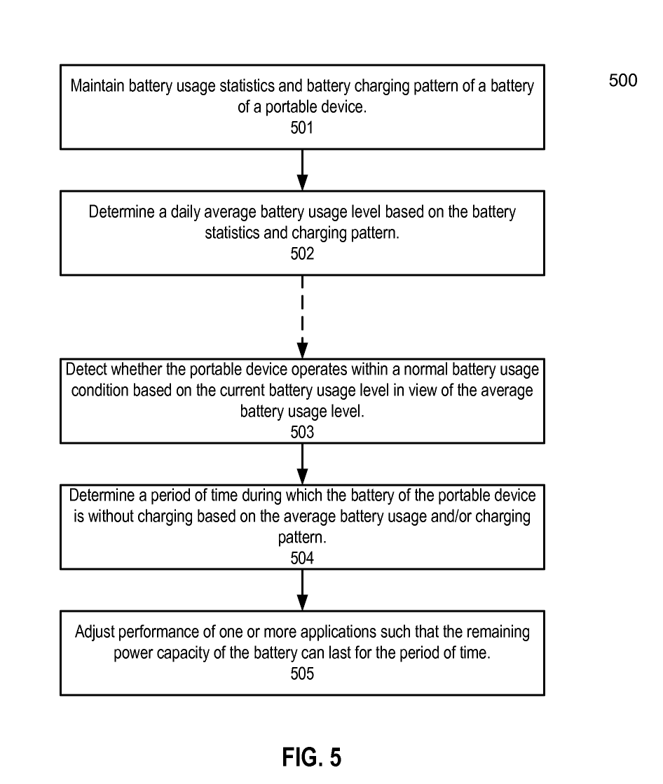

FIG. 5 is a flow diagram illustrating a method for inferring user intent from battery usage heuristics and charging pattern according to another embodiment of the invention. Method 500 may be performed by system 300 of FIG. 3, which may be implemented as processing logic in hardware, software, or a combination thereof. Referring to FIG. 5, at block 501, batter usage heuristics and battery charging pattern are maintained in a database stored in a storage device of a portable device. At block 502, an average battery usage level is determined based on the battery usage heuristics and charging pattern. Subsequently at block 503, processing logic detects whether the portable device operates within a normal battery usage condition based on the current battery usage level at the point in time in view of the average battery usage level. At block 504, processing logic further estimates a period of time going forward during which the battery of the portable device is without charging based on the average battery usage level and/or charging pattern. At block 505, performance of one or more programs is adjusted (e.g., increase or decrease) based on whether the portable device operates in an abnormal condition and/or the estimated period of time without charging, such that the remaining power capacity of the battery can last for the period of time.

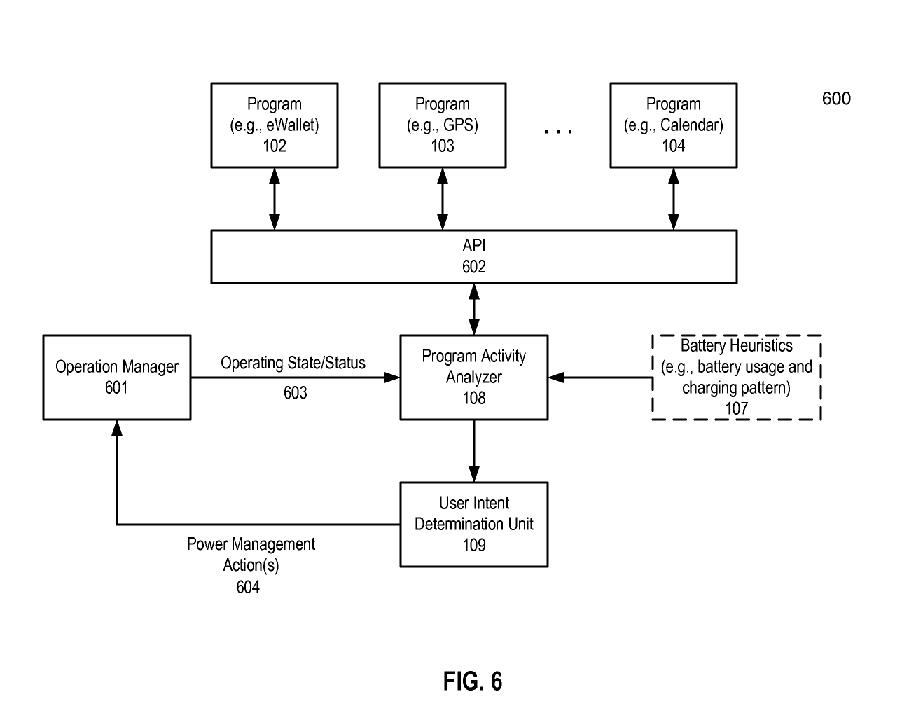

FIG. 6 is a block diagram illustrating a user level power management system according to another embodiment of the invention. System 600 may be implemented as part of system 100 of FIG. 1. Referring to FIG. 6, in this embodiment, activities of programs 102-104 are monitored or communicated to program activity analyzer 108 via API 602 (e.g., via a push or poll method, or via interrupt). In addition, program activity analyzer 108 is communicatively coupled to operation manager 601 of an operating system. Operation manager 601 may represent a combination of one or more of a resource manager, an application launcher (e.g., springboard), a scheduler, a power management unit, and/or other components of the operating system. Operation manager 601 is configured to manage or collect information such as operating state or status 603 of certain hardware and/or software operations (e.g., entering an airplane mode) and to communicate such information to program activity analyzer 108. Based on the operating state or status information 603, program activity analyzer 108 is configured to collect information 603 with activity data collected from programs 102-104 and optional battery usage heuristics and charging pattern 107.

User intent determination unit 109 then infers user intent and possible subsequent user interaction with the portable device at the point in time based on the information gathered by program activity analyzer 108. Based on the user intent and the possible subsequent user interaction, user intent determination unit 109 transmits a signal 604 to operation manager 601 to recommend a power management action to be performed on the portable device. In response, operation manager 601 may perform certain power management actions on the hardware such as shutting down the WiFi, lower the display brightness, etc., as well as software such as causing certain programs to change its behavior to reduce certain performance of the programs. Alternatively, if it is determined based on the user intent that the remaining power capacity of the battery can last much longer than the estimated period of time without charging, the performance of the portable device may be increased to further enhance user experience.

Again, the goal of user level power management is to optimize the performance, battery life and thermal response of devices and computers. If the power management system has enough information about what the user is doing, it may be able to improve performance or save power which in turn could extend battery life or reduce system temperature. Applications can be a source of input to a user power management system, explicitly those that outline the user's near future in the real world.

The above techniques can be applied to a variety of different situations. For example, presenting a boarding pass for checking into a flight on a plane tells the power management system that the user is likely going to be in airplane mode for the duration of the flight. When in the near future the user enables airplane mode, the power management system can infer that the user will want their device's battery to last for the duration of the flight, and will not likely have access to power until after the flight. The power management system could respond by sacrificing some performance in favor of stretching the battery to last for the duration of the flight. Simply knowing that the device is in airplane mode gives part of this information, but it lacks a likely duration that airplane mode will be enabled and cannot make a useful prediction about how much battery conservation should be applied. By using the fact that the user has checked in for a flight, and the metadata from the boarding pass, the power management system is gets two data points for airplane mode and a likely duration.

Another example could be using an eWallet application such as Passbook to purchase a drink at a coffee house. This coupled with GPS location largely staying the same would suggest that the user will be enjoying their drink in the coffee house for the next 20 to 30 minutes. If they should be using their device in that time period they are likely to be doing so intently, (reading the news, playing a game, etc.), such that they would like their device to be particularly responsive. This sort of information could tell the power management system that for the next 20-30 minutes it is in the user's best interest to sacrifice some battery life in favor of improved performance.

In a further example, if the user starts watching a movie using a media player of the portable device, the system can determine whether the battery can last for the duration of the movie based on the metadata of the movie. If the remaining power capacity of the battery cannot last that long, certain power management actions may be performed, such as reducing performance of other applications since the user unlikely use those applications while watching the movie. Alternatively, the frame rate may be reduced in order to reduce power consumption. Furthermore, it the system detects that the device is operating in a relatively dark environment (e.g., playing a video game), which may be detected via an ambient or light sensor (and its corresponding application), the system may automatically reduces the backlight of the display to further reduce power consumption of a general-purpose processor such as a central processing unit (CPU) and/or to increase performance of a special-purpose processor such as a graphical processing unit (GPU).

It is important to note that the monitoring, detection, and power management actions described above are performed automatically without user intervention or user knowledge. Unlike convention power management systems, the user level power management system described throughout this application does not focus on detection of power usage and notification of the user regarding such power usage (e.g., alert to the user that the battery is running low. Rather, the user level power management system focuses on user behavior of a particular user and automatically adjusts the operations of the portable device in order to improve the user experience with the portable device. Each user may have different behavior and pattern, by employing a user agent within the portable device, the user level power management system can “learn” that particular user's behavior and adapt to that particular user's life style, even without the user knowledge. A typical user may not be interested in the notification of a battery usage level. Rather, the user may be more interested in enjoying the experience of the portable device without interruption by the unwelcome notification. All a user cares about is that the battery can support whatever the user intends to do at the moment, regardless how the system fulfills such a requirement.

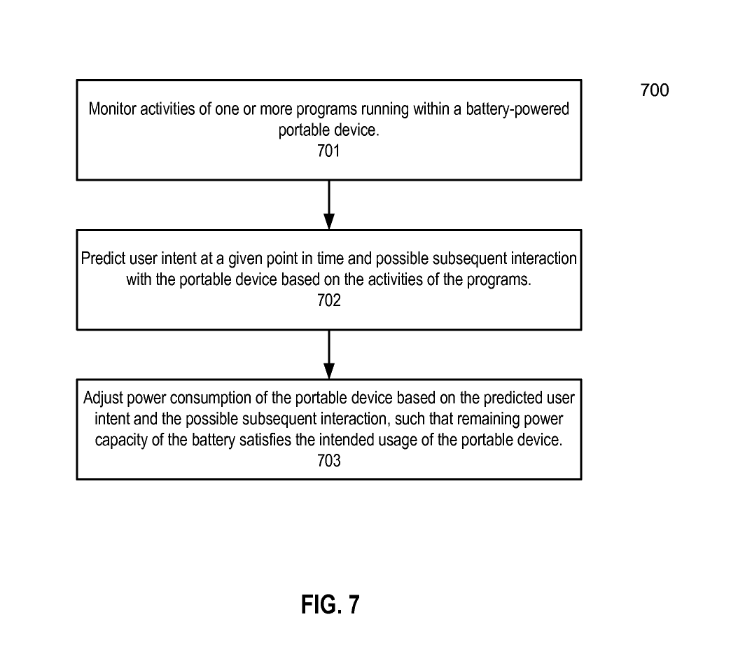

FIG. 7 is a flow diagram illustrating a method for user level power management according to another embodiment of the invention. Method 700 may be performed by system 600 of FIG. 6, which may be implemented as processing logic in hardware, software, or a combination thereof. Referring to FIG. 7, at block 701, activities of one or more programs (e.g., applications, processes, device drivers) running within a battery-powered portable device are monitored. At block 702, user intent at a given point in time and possible subsequent interaction with the portable device is predicted based on the activities of the programs. At block 703, power consumption of the portable device is adjusted based on the user intent and possible subsequent interaction with the portable device, such that the remaining power capacity of the battery can satisfy the intended usage of the portable device.

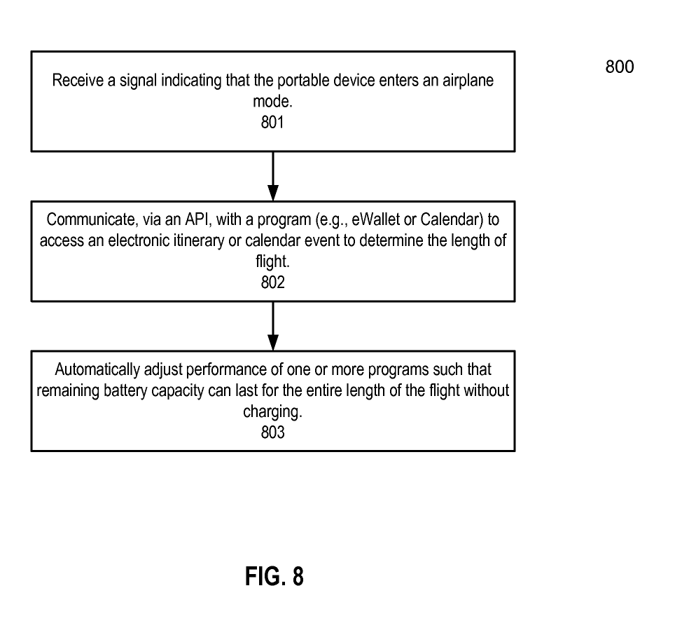

FIG. 8 is a flow diagram illustrating a method for user level power management according to another embodiment of the invention. Method 800 may be performed by system 600 of FIG. 6, which may be implemented as processing logic in hardware, software, or a combination thereof. Referring to FIG. 8, at block 801, a signal is received indicating that the portable device enters an airplane mode. In response at block 802, processing logic communicates with a program (e.g., eWallet or calendar application) to access an electronic itinerary or calendar event to determine the length of the flight. At block 803, processing logic automatically adjusts performance of one or more programs such that remaining battery capacity can last for the entire length of flight without charging.

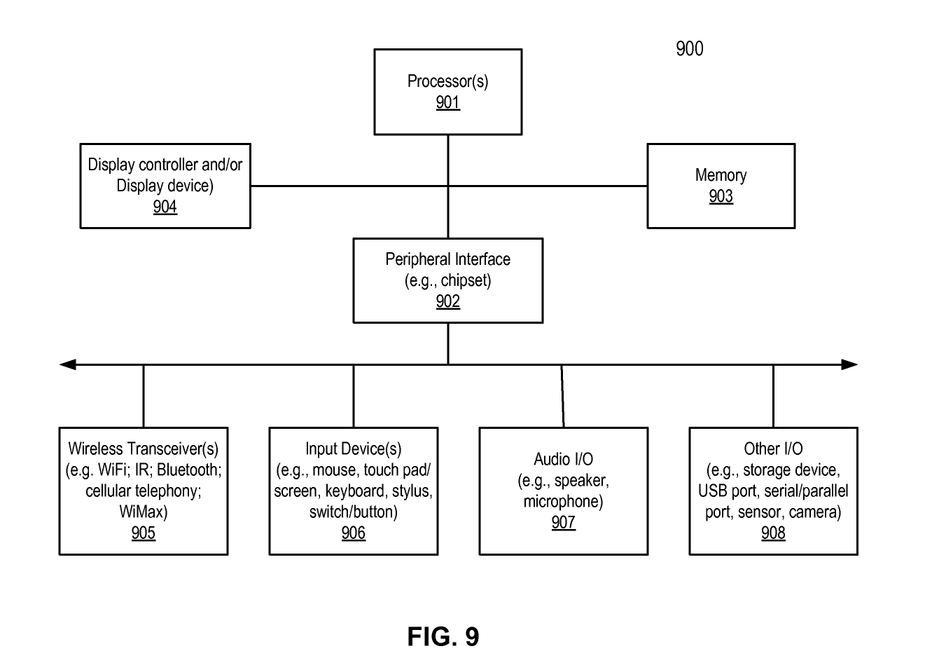

FIG. 9 is a block diagram illustrating an example of a data processing system which may be used with one embodiment of the invention. For example, system 900 may represents any of data processing systems described above performing any of the processes or methods described above. System 900 may represent a desktop (e.g., iMac™ available from Apple Inc. of Cupertino, Calif.), a laptop (e.g., MacBook™), a tablet (e.g., iPad™), a server, a mobile phone (e.g., iPhone™), a media player (e.g., iPod™ or iPod Touch™), a personal digital assistant (PDA), a personal communicator, a gaming device, a network router or hub, a wireless access point (AP) or repeater, a set-top box, or a combination thereof.

Referring to FIG. 9, in one embodiment, system 900 includes processor 901 and peripheral interface 902, also referred to herein as a chipset, to couple various components to processor 901 including memory 903 and devices 905-908 via a bus or an interconnect. Processor 901 may represent a single processor or multiple processors with a single processor core or multiple processor cores included therein. Processor 901 may represent one or more general-purpose processors such as a microprocessor, a central processing unit (CPU), or the like. More particularly, processor 901 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 901 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 901 is configured to execute instructions for performing the operations and steps discussed herein.

Peripheral interface 902 may include memory control hub (MCH) and input output control hub (ICH). Peripheral interface 902 may include a memory controller (not shown) that communicates with a memory 903. Peripheral interface 902 may also include a graphics interface that communicates with graphics subsystem 904, which may include a display controller and/or a display device. Peripheral interface 902 may communicate with graphics device 904 via an accelerated graphics port (AGP), a peripheral component interconnect (PCI) express bus, or other types of interconnects.

An MCH is sometimes referred to as a Northbridge and an ICH is sometimes referred to as a Southbridge. As used herein, the terms MCH, ICH, Northbridge and Southbridge are intended to be interpreted broadly to cover various chips who functions include passing interrupt signals toward a processor. In some embodiments, the MCH may be integrated with processor 901. In such a configuration, peripheral interface 902 operates as an interface chip performing some functions of the MCH and ICH. Furthermore, a graphics accelerator may be integrated within the MCH or processor 901.

Memory 903 may include one or more volatile storage (or memory) devices such as random access memory (RAM), dynamic RAM (DRAM), synchronous DRAM (SDRAM), static RAM (SRAM), or other types of storage devices. Memory 903 may store information including sequences of instructions that are executed by processor 901, or any other device. For example, executable code and/or data of a variety of operating systems, device drivers, firmware (e.g., input output basic system or BIOS), and/or applications can be loaded in memory 903 and executed by processor 901. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 902 may provide an interface to IO devices such as devices 905-908, including wireless transceiver(s) 905, input device(s) 906, audio IO device(s) 907, and other IO devices 908. Wireless transceiver 905 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 906 may include a mouse, a touch pad, a touch sensitive screen (which may be integrated with display device 904), a pointer device such as a stylus, and/or a keyboard (e.g., physical keyboard or a virtual keyboard displayed as part of a touch sensitive screen). For example, input device 906 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 907 may include a speaker and/or a microphone to facilitate voice-enabled functions, such as voice recognition, voice replication, digital recording, and/or telephony functions. Other optional devices 908 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 908 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 9 illustrates various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method, comprising:
monitoring, by a user agent of an operating system executed within a portable device, activities of a plurality of programs running within the portable device;
predicting, by the user agent, user intent at a given point in time and possible subsequent user interaction with the portable device based on the activities of the program; and
adjusting power consumption of the portable device based on the predicted user intent and subsequent user interaction of the portable device, such that remaining power capacity of a battery of the portable device satisfies intended usage of the portable device.

2. The method of claim 1, wherein the power consumption of the portable device is adjusted automatically without user intervention or knowledge.

3. The method of claim 1, wherein adjusting power consumption of the portable device comprises disabling a function of a first of the programs to reduce power consumption, if the subsequent usage of the portable device consumes more than the remaining power capacity of the battery.

4. The method of claim 1, wherein adjusting power consumption of the portable device comprises increasing performance of a second of the programs, if the subsequent usage of the portable device consumes less than the remaining power capacity of the battery.

5. The method of claim 1, wherein predicting user intent and possible subsequent user interaction with the portable device comprises communicating via an program programming interface (API) with a third program to estimate a period of time during which the portable device is without charging.

6. The method of claim 5, wherein the third program provides a travel itinerary that specifies the period of time during which the portable device could possibly operate in an airplane mode.

7. The method of claim 6, further comprising in response to a signal indicating that the portable device is operating in the airplane mode, adjusting power consumption of at least one of the programs such that the remaining power capacity of the battery can last the period of time without charging.

8. The method of claim 5, wherein the third program is a global positioning system (GPS) program indicating a location of the portable device.

9. The method of claim 8, further comprising:
determining possible actions that a user of the portable device would possibly do and how long the user would stay at the location; and
adjusting power consumption of at least one of the programs such that the remaining power capacity of the battery can last the period of time at the location without charging.

10. The method of claim 1, wherein predicting user intent and possible subsequent user interaction with the portable device comprises:
communicating via an program programming interface (API) with a fourth program to determine an ambient condition of an operating environment; and
automatically reducing backlight of a display of the portable device if the portable device operates in a dark environment.

11. A non-transitory computer-readable medium for storing instructions, which when executed by a processor, cause the processor to perform a method, the method comprising:
monitoring, by a user agent of an operating system executed within a portable device, activities of a plurality of programs running within the portable device;
predicting, by the user agent, user intent at a given point in time and possible subsequent user interaction with the portable device based on the activities of the program; and
adjusting power consumption of the portable device based on the predicted user intent and subsequent user interaction of the portable device, such that remaining power capacity of a battery of the portable device satisfies intended usage of the portable device.

12. The non-transitory computer-readable medium of claim 11, wherein the power consumption of the portable device is adjusted automatically without user intervention or knowledge.

13. The non-transitory computer-readable medium of claim 11, wherein adjusting power consumption of the portable device comprises disabling a function of a first of the programs to reduce power consumption, if the subsequent usage of the portable device consumes more than the remaining power capacity of the battery.

14. The non-transitory computer-readable medium of claim 11, wherein adjusting power consumption of the portable device comprises increasing performance of a second of the programs, if the subsequent usage of the portable device consumes less than the remaining power capacity of the battery.

15. The non-transitory computer-readable medium of claim 11, wherein predicting user intent and possible subsequent user interaction with the portable device comprises communicating via an application programming interface (API) with a third program to estimate a period of time during which the portable device is without charging.

16. The non-transitory computer-readable medium of claim 15, wherein the third program provides a travel itinerary that specifies the period of time during which the portable device could possibly operate in an airplane mode.

17. The non-transitory computer-readable medium of claim 16, wherein the method further comprises in response to a signal indicating that the portable device is operating in the airplane mode, adjusting power consumption of at least one of the programs such that the remaining power capacity of the battery can last the period of time without charging.

18. The non-transitory computer-readable medium of claim 15, wherein the third program is a global positioning system (GPS) program indicating a location of the portable device.

19. The non-transitory computer-readable medium of claim 18, the method further comprises:
determining possible actions that a user of the portable device would possibly do and how long the user would stay at the location; and
adjusting power consumption of at least one of the programs such that the remaining power capacity of the battery can last the period of time at the location without charging.

20. A portable device, comprising:
a user agent to monitor activities of a plurality of programs running within the portable device and to predict user intent at a given point in time and possible subsequent user interaction with the portable device based on the activities of the program; and
power management logic coupled to the user agent to adjust power consumption of the portable device based on the predicted user intent and subsequent user interaction of the portable device, such that remaining power capacity of a battery of the portable device satisfies intended usage of the portable device.

21. The portable device of claim 20, wherein the power consumption of the portable device is adjusted automatically without user intervention or knowledge.

22. The portable device of claim 20, wherein adjusting power consumption of the portable device comprises disabling a function of a first of the programs to reduce power consumption, if the subsequent usage of the portable device consumes more than the remaining power capacity of the battery.

23. The portable device of claim 20, wherein adjusting power consumption of the portable device comprises increasing performance of a second of the programs, if the subsequent usage of the portable device consumes less than the remaining power capacity of the battery.

24. The portable device of claim 20, wherein predicting user intent and possible subsequent user interaction with the portable device comprises communicating via an program programming interface (API) with a third program to estimate a period of time during which the portable device is without charging.
